(19) United States
(12) Patent Application Publication
(10) Pub. No.: US 2020/0356553 A1
(43) Pub. Date: Nov. 12, 2020

(54) AUTOMATED GENERATION OF RECOMMENDER DIALOG USING STRUCTURED DATA

(71) Applicant: INTERNATIONAL BUSINESS MACHINES CORPORATION, Armonk, NY (US)

(72) Inventors: Nicholas B. Moss, Atlanta, GA (US); Donna K. Byron, Petersham, MA (US); Benjamin L. Johnson, Baltimore, MD (US); Joanne M. Santiago, Austin, TX (US)

(21) Appl. No.: 16/408,156

(22) Filed: May 9, 2019

(51) Int. Cl. G06F 16/242; G06F 16/22

(52) U.S. Cl. CPC G06F 16/243; G06F 16/2246

(57) ABSTRACT

A system for engaging in a recommendation-dialog with a user includes a memory having instructions therein. The system also includes at least one processor in communication with the memory. The at least one processor is configured to execute the instructions to access a recommendation domain, use a structure-mapping technique to generate a data structure based on source material from the recommendation domain, use semantic analyses to generate an ontology based on the data structure and the recommendation domain, generate recommendation-dialog queries based on properties of the data structure, generate a dialog tree based on the ontology and the recommendation-dialog queries, receive a recommendation dialog input, navigate the dialog tree to determine a recommendation, and provide the recommendation to the user.

### BACKGROUND

A recommendation-dialog system is, generally, an interactive computer application that navigates a dialog tree to recommend a product or service to the user. Many recommendation-dialog systems require manual pre-configuration of their dialog trees. Moreover, the dialog trees in many recommendation-dialog systems are static (i.e., not automatically reconfigurable).

### SUMMARY

A method for engaging in a recommendation-dialog with a user is disclosed. The method includes accessing a recommendation domain, using a structure-mapping technique to generate a data structure based on source material from the recommendation domain, using semantic analyses to generate an ontology based on the data structure and the recommendation domain, generating recommendation-dialog queries based on properties of the data structure, generating a dialog tree based on the ontology and the recommendation-dialog queries, receiving a recommendation dialog input, navigating the dialog tree to determine a recommendation, and providing the recommendation to the user.

A system for engaging in a recommendation-dialog with a user is also disclosed. The system includes a memory having instructions therein. The system also includes at least one processor in communication with the memory. The at least one processor is configured to execute the instructions to access a recommendation domain, use a structure-mapping technique to generate a data structure based on source material from the recommendation domain, use semantic analyses to generate an ontology based on the data structure and the recommendation domain, generate recommendation-dialog queries based on properties of the data structure, generate a dialog tree based on the ontology and the recommendation-dialog queries, receive a recommendation dialog input, navigate the dialog tree to determine a recommendation, and provide the recommendation to the user.

A computer program product is also disclosed. The computer program product includes a computer readable storage medium having program instructions embodied therewith. The program instructions are executable by at least one processor to cause the at least one processor to access a recommendation domain, use a structure-mapping technique to generate a data structure based on source material from the recommendation domain, use semantic analyses to generate an ontology based on the data structure and the recommendation domain, generate recommendation-dialog queries based on properties of the data structure, generate a dialog tree based on the ontology and the recommendation-dialog queries, receive a recommendation dialog input, navigate the dialog tree to determine a recommendation, and provide the recommendation to the user.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating a recommendation-dialog environment in accordance with aspects of the present disclosure.

FIG. 2 is a block diagram illustrating a hardware architecture of a data processing system in accordance with aspects of the present disclosure.

FIG. 3 is a flowchart illustrating a computer-implemented recommendation-dialog method in accordance with aspects of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

A “module” or “unit” as referenced herein comprises one or more hardware or electrical components such as electrical circuitry, processors, and memory that may be specially configured to perform a particular function. The memory may comprise volatile memory or non-volatile memory that stores data such as, but not limited to, computer executable instructions, machine code, and other various forms of data. The module or unit may be configured to use the data to execute one or more instructions to perform one or more tasks. In certain instances, a module or unit may also refer to a particular set of functions, software instructions, or circuitry that is configured to perform a specific task. For example, a module or unit may comprise software components such as, but not limited to, data access objects, service components, user interface components, application programming interface (“API”) components; hardware components such as electrical circuitry, processors, and memory; and/or a combination thereof. As referenced herein, computer executable instructions may be in any form including, but not limited to, machine code, assembly code, and high-level programming code written in any programming language.

Also, as used herein, the term “communicate” and inflections thereof mean to receive and/or transmit data or information over a communication link. The communication link may include both wired and wireless links, and may comprise a direct link or may comprise multiple links passing through one or more communication networks or network devices such as, but not limited to, routers, firewalls, servers, and switches. The communication networks may comprise any type of wired or wireless network. The networks may include private networks and/or public networks such as the Internet. Additionally, in some embodiments, the term communicate may also encompass internal communication between various components of a system and/or with an external input/output device such as a keyboard or display device.

As referenced herein, a “recommendation domain” (or simply “domain”) is a field or body of information and/or knowledge that a recommendation-dialog system may use in making a recommendation. A recommendation domain may comprise one or more corpora of documents and/or other records, such as, but not limited to, publications, books, magazines, articles, research papers, audio/visual content and/or transcriptions thereof, online content, and/or other data, and/or a knowledge graph and/or other ontological information based on one or more such corpora.

As referenced herein, a “knowledge graph” is, generally, a representation of a domain based on a graph data structure with nodes and edges that link related data such as facts, people, and places together.

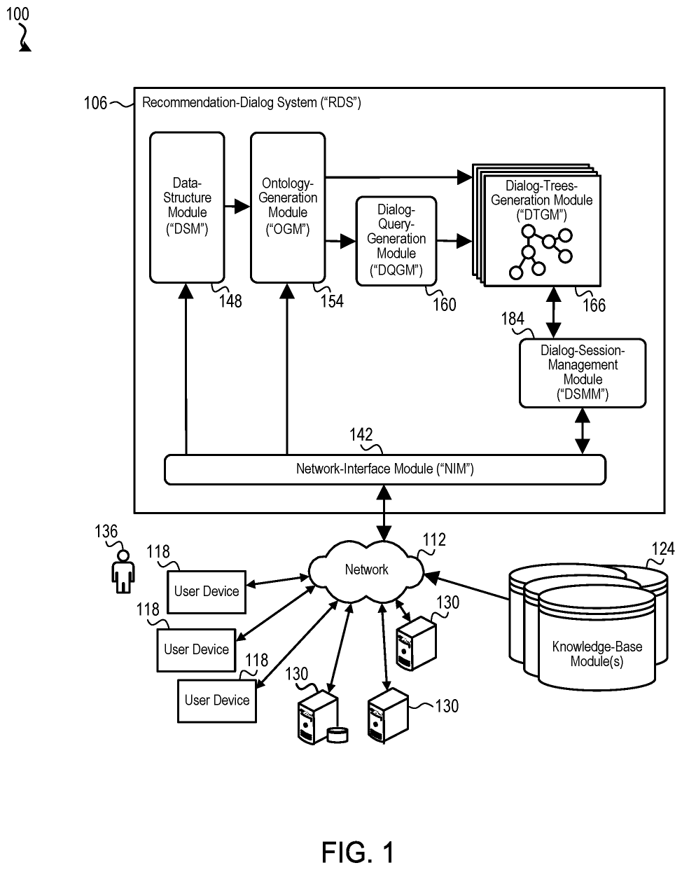

FIG. 1 is a block diagram illustrating a recommendation-dialog environment (“RDE”) 100 in accordance with aspects of the present disclosure. The RDE 100 includes a recommendation-dialog system (“RDS”) 106 (described further below). The RDE 100 also includes a network 112, one or more user devices 118, one or more knowledge-base modules 124, one or more other network devices 130, and a user 136.

The network 112 is communicatively coupled to the RDS 106. The network 112 may comprise any type of network that enables the RDS 106 to communicate with the one or more user devices 118 as well as with the one or more knowledge-base modules 124 and other devices such as the one or more network devices 130. For example, the network 112 may comprise one or more wired and/or wireless networks such as, but not limited to, one or more radio networks (e.g., cellular network or mobile network), one or more local area networks (“LANs”), one or more wide area networks (“WANs”), one or more metropolitan area networks (“MANs”), etc. The network 112 may also comprise one or more private networks and/or one or more public networks (such as, but not limited to, the Internet).

Each of the one or more user devices 118 is communicatively coupled to the network 112 and (through the network 112) to the RDS 106. Each of the one or more user devices 118 may comprise any type of electronic device that allows the user 136 to audibly, textually, or otherwise suitably interact with the RDS 106 through the network 112. Non-limiting examples of one of the one or more user devices 118 include a personal computer (desktop or laptop), a mobile device (e.g., personal digital assistant (“PDA”), smart phone, tablet, etc.), and a cognitive voice assistant device (e.g., Amazon's Alexa®, a Google Home® device, etc.).

Each of the one or more knowledge-base modules 124 is communicatively coupled to the network 112 and (through the network 112) to the RDS 106. The one or more knowledge-base modules 124 store and provide access to one or more recommendation domains. Some embodiments of the RDS 106 may include one or more ingestion pipelines (not shown) configured to extract information from input documents and configured to use the extracted information to generate the one or more recommendation domains. The input documents may include unstructured data (e.g., freeform text), structured data such as table data, and/or one or more graphical representations of data. Such embodiments of the RDS 106 may be configured to obtain the input documents from one or more document training databases, publicly available online sources, and/or various other sources, and may be configured to download the one or more recommendation domains (through the network 112) into the one or more knowledge-base modules 124. Some embodiments of the RDS 106 may be configured to collect or otherwise obtain the one or more recommendation domains from one or more external computers, machines, modules, and/or devices and configured to download the one or more recommendation domains (through the network 112) into the one or more knowledge-base modules 124. In some embodiments, one or more external computers, machines, modules, and/or devices may generate the one or more recommendation domains and may download or otherwise store the one or more recommendation domains into the one or more knowledge-base modules 124. In some embodiments, one or more of the recommendation domains may comprise the YAGO™ knowledge base, which has been a joint project of the Max Planck Institute for Informatics and the Telecom ParisTech University. The YAGO™ knowledge base has been made available at https://www.mpi-inf.mpg.de/departments/databases-and-information-systems/research/yago-naga/yago/. In some embodiments, one or more of the recommendation domains may comprise the Google® Knowledge Graph, which has been made available (through an API) by Google. The Google® Knowledge Graph Search API has been made available at https://developers.google.com/knowledge-graph/. In any event, the one or more knowledge-base modules 124 may store any suitable one or more recommendation domains.

Each of the one or more other network devices 130 is communicatively coupled to the network 112 and (through the network 112) to the RDS 106. Each of the one or more other network devices 130 may comprise an Internet of Things (“IoT”) device (such as, but not limited to, a vehicle, a home appliance, and/or other thing embedded with electronics, software, sensors, actuators, and connectivity that enables it to send suitable data over the network 112), or any other server, database, and/or application that can provide suitable structured data to the RDS 106.

The RDS 106 includes a network interface module (“NIM”) 142. The NIM 142 is communicatively coupled to the network 112 and (through the network 112) to the one or more user devices 118, the one or more knowledge-base modules 124, and the one or more other network devices 130. The NIM 142 is configured to communicatively couple the RDS 106 to the one or more user devices 118, the one or more knowledge-base modules 124, and the one or more other network devices 130 in accordance with aspects of the present disclosure.

The RDS 106 also includes a data-structure module (“DSM”) 148. The DSM 148 is communicatively coupled to the NIM 142. The DSM 148 is configured to generate or otherwise obtain a data structure suitable for generating an ontology (described further below) in accordance with aspects of the present disclosure. For generating the data structure, the DSM 148 comprises a structure-mapping engine (“SME”) and/or any other suitable feature(s) configured to apply structure-mapping and/or other suitable techniques to generate the data structure based on terms/terminology (“source material”) from the recommendation domain. Non-limiting examples of sources of potentially suitable source material include body text, headings, footers, captions, excerpts, etc. and/or the entireties of one or more product or service brochures or catalogs, one or more website presentations or listings of products or services, and/or one or more product or service ratings, reviews, or testimonials that have been produced by one or more consumers, customers, shoppers, and/or critics. The DSM 148 is also configured to append the data structure (as metadata) to the source material. Here, it should be appreciated that many artificial intelligence applications rely on deep learning, which can require examining massive amounts of data. By contrast, applying structure-mapping in accordance with aspects of the present disclosure provides a system that can generate a useable data structure much more efficiently and, in some embodiments, based on as little as a single product catalog or testimonial. For example, in an embodiment that may provide a recommendation for automobile tires, the DSM 148 may be configured to generate the following data structure from a product catalog retrieved (through the network 112 and the NIM 142) from the recommendation domain: Data Structure (Example):

{
″name″: ″All-Season Radial″,
″brand″: ″Milestar″,
″model″: ″MS932″,
″rim_size″: ″16 inches″,
″aspect_ratio″: ″55″,
″section_width″: ″205 millimeters″,
″speed_rating″: ″V″,
″tire_diameter″: ″24.9 inches″,
″dimensions″: ″24.9 × 24.9 × 8.4 inches″,
″load_index_rating″: ″91″,
″siping″: ″not provided″,
″tread_pattern″: ″symmetrical″,
″highest_cost_or_price″: ″$125.00″,
. . .
}

For otherwise obtaining the data structure, the DSM 148 may be configured to receive (through the network 112 and the NIM 142) and adopt a predetermined or predefined data structure from the one or more user devices 118, the one or more knowledge-base modules 124, the one or more other network devices 130, and/or one or more suitable Internet resources. For example, in an embodiment that may provide a recommendation for a music album, the DSM 148 may be configured to receive (through the network 112 and the NIM 142) and adopt a predefined musicAlbum.genre->“Classical” schema from Schema.org as the suitable data structure. “Schema.org is a collaborative, community activity with a mission to create, maintain, and promote schemas for structured data on the Internet, on web pages, in email messages, and beyond.” https://schema.org/. Further, the DSM 148 may also be configured to populate such a predetermined or predefined data structure with appropriate corresponding terms or other information from the recommendation domain. The DSM 148 is also configured to append the data structure (as metadata) to the source material.

The RDS 106 also includes an ontology-generation module (“OGM”) 154. The OGM 154 is communicatively coupled to the DSM 148. The OGM 154 is also communicatively coupled to the NIM 142. The OGM 154 is configured to use bag-of-words, predicate-argument-structure (“PAS”), and/or one or more other suitable types of semantic analyses to generate a semantic data model, knowledge graph, or other suitable ontology based on the data structure generated by the DSM 148 (described above) and suitable information from the recommendation domain. More particularly, the OGM 154 is configured to generate the ontology by reviewing and analyzing the recommendation domain for meanings, relationships, significances, and/or other ontological attributes or characteristics of terms or other information that comprise the data structure. For example, in an embodiment that may provide a recommendation for automobile tires, the OGM 154 may be configured to, based on the above-disclosed example data structure and the following words from a product review or testimonial (from the recommendation domain), use a bag-of-words analysis to generate the following semantic data model:

### Product Review (Example):

We had Milestar MS321 All-Season Radial 205/55R16 91 V tires mounted and balanced on the VW Jettas a few weeks ago. They appear very well made, and well finished for about ½ the price of other tires. The OEM supplied Korean made Hankook tires and Bridgestone tires that were originally on our vehicles cost significantly more, as do the major USA brand tires. The siping (traction enhancing slices/grooves through the tread blocks) and symmetrical tread pattern look well designed. Moreover, the initial road test was VERY positive—100% as good as pricier Michelin, Bridgestone, and even as good as the affordably priced Hankook tires of identical size that were OEM on some of the vehicles. Sidewall rigidity (handling and ride) is comparable to the other tires. Although handling is not as tight as the low profile Michelin tires on 17″ rims (at 3× the price), that was expected, as the two kinds of tires are really not directly comparable due to the profile and rim size (16″ versus 17″ diameter) differences.

### Semantic Data Model (Example):

brand(Bridgestone, 2)

brand(Hankook, 2)

brand(Michelin, 2)

brand(Milestar, 1)

highest_cost_or_price(Bridgestone, 2)

highest_cost_or_price(Hankook, 1)

highest_cost_or_price(Michelin, 1)

highest_cost_or_price(They, 1)

rim_size(Hankook, 1)

rim_size(Michelin, 1)

rim_size(17″, 1)

rim_size(16″, 1)

aspect_ratio(55, 1)

load_index_rating (91, 1)

model(MS321, 1)

name(All-Season Radial, 1)

section_width(205, 1)

siping(factory provided, 1)

speed_rating (V, 1)

tread_pattern(symmetrical, 1)

The RDS 106 also includes a dialog-query-generation module (“DQGM”) 160. The DQGM 160 is communicatively coupled to the OGM 154. The DQGM 160 is configured to use one or more grammar and/or other natural language generation (“NLG”) techniques to generate one or more recommendation-dialog queries based on properties of the data structure. More particularly, in some embodiments the DQGM 160 is configured to generate at least two types of recommendation-dialog queries: “Type 1” recommendation-dialog queries, such that each of the Type 1 recommendation-dialog queries is directed to soliciting an indication of whether a particular property of the data structure is relevant to the recommendation being sought; and “Type 2” recommendation-dialog queries, such that each of the Type 2 recommendation-dialog queries is directed to soliciting an identification or selection of a particular property of the data structure that is to be intrinsic to the ultimately recommended product or service. The DQGM 160 is configured to generate the Type 1 and Type 2 recommendation-dialog queries by inserting properties of the data structure into respective recommendation-dialog-query templates related to the properties. For example, in some embodiments a Type 1 recommendation-dialog-query template may be “Do you care about [data structure property]?” and a Type 2 recommendation-dialog-query template may be “What [data structure property] are you looking for?” In some embodiments, the DQGM 160 may also be configured to generate at least a third type of recommendation-dialog queries: “Type 3” recommendation-dialog queries, such that each of the Type 3 recommendation-dialog queries is a more open-ended query directed to soliciting a response that might help the RDS 106 choose an appropriate Type 1 recommendation-dialog query and/or an appropriate an appropriate Type 2 recommendation-dialog query. Thus, for example, in an embodiment that may provide a recommendation for automobile tires, the DQGM 160 may be configured to, based on the properties of the above-disclosed example data structure, generate the following recommendation-dialog queries:

Recommendation-Dialog Queries (Example):
{
Do you care about brand? (Type 1)
Do you care about highest cost or price? (Type 1)
Do you care about rim size? (Type 1)
Do you care about aspect ratio? (Type 1)
Do you care about load index rating? (Type 1)
Do you care about model? (Type 1)
Do you care about name? (Type 1)
Do you care about section width? (Type 1)
Do you care about siping? (Type 1)
Do you care about speed rating? (Type 1)
Do you care about tread pattern? (Type 1)
What brand are you looking for? (Type 2)
What highest cost or price are you looking for? (Type 2)
What rim size are you looking for? (Type 2)
What aspect ratio are you looking for? (Type 2)
What load index rating are you looking for? (Type 2)
What model are you looking for? (Type 2)
What name are you looking for? (Type 2)
What section width are you looking for? (Type 2)
What siping are you looking for? (Type 2)
What speed rating are you looking for? (Type 2)
What tread pattern are you looking for? (Type 2)
What kinds of things are you looking for? (Type 3)
What else are you looking for? (Type 3)
. . .
}

The RDS 106 also includes a dialog-trees-generation module (“DTGM”) 166. The DTGM 166 is communicatively coupled to the OGM 154. The DTGM 166 is also communicatively coupled to the DQGM 160. The DTGM 166 is configured to generate one or more dialog trees based on the ontology and the recommendation-dialog queries. More particularly, in some embodiments the DTGM 166 may be configured to dynamically arrange the recommendation-dialog queries into the one or more dialog trees (in which Type 1 recommendation-dialog queries are prioritized over Type 2 recommendation-dialog queries and in which Type 3 recommendation-dialog queries are used as fallbacks for choosing appropriate Type 1 recommendation-dialog queries and/or appropriate Type 2 recommendation-dialog queries) according to the relative relevancies of the data structure properties of the recommendation-dialog queries, with the relative relevancies considered to be the total numbers of occurrences of each corresponding data structure property in the semantic data model. For example, in an embodiment that may provide a recommendation for automobile tires, when the OGM 154 generates the above-disclosed example semantic data model, in which there are 7 total occurrences of the “brand” property (consisting of 2 occurrences of “Bridgestone” relevant to “brand,” 2 occurrences of “Hankook” relevant to “brand,” 2 occurrences of “Michelin” relevant to “brand,” and 1 occurrence of “Milestar” relevant to “brand”), 5 total occurrences of the “highest_cost_or_price” property (consisting of 2 occurrences of “Bridgestone” relevant to “highest_cost_or_price,” 1 occurrence of “Hankook” relevant to “highest_cost_or_price,” 1 occurrence of “Michelin” relevant to “highest_cost_or_price,” and 1 occurrence of “They” relevant to “highest_cost_or_price”), 4 total occurrences of the “rim_size” property (consisting of 1 occurrence of “Hankook” relevant to “rim_size,” 1 occurrence of “Michelin” relevant to “rim_size,” 1 occurrence of “17″” relevant to “rim_size,” and 1 occurrence of “16″” relevant to “rim_size,”), and 1 occurrence each of the “aspect_ratio,” “load_index_rating,” “model,” “name,” “section_width,” “siping,” “speed_rating,” and “tread_pattern” properties, and when the DQGM 160 generates the above-disclosed example recommendation-dialog queries, the DTGM 166 may generate one or more dialog trees that will cause the RDS 106 to engage in one more recommendation dialogs along the following lines:

### Recommendation Dialog (Example):

RDS 106: “Do you care about brand?”

user 136: “Yes”

RDS 106: “What brand are you looking for?”

user 136: “Milestar”

RDS 106: “Do you care about highest cost or price?”

user 136: “Yes”

RDS 106: “What highest cost or price are you looking for?”

user 136: “$200”

RDS 106: “Do you care about rim size?”

user 136: “Yes”

RDS 106: “What rim size are you looking for?”

user 136: “16 inch”

RDS 106: “Do you care about aspect ratio?”

user 136: “Yes”

RDS 106: “What aspect ratio are you looking for?”

user 136: “55”

RDS 106: “Do you care about load index rating?”

user 136: “Yes”

RDS 106: “What load index rating are you looking for?”

user 136: “91”

RDS 106: “Do you care about model?”

user 136: “No”

RDS 106: “Do you care about name?”

user 136: “Yes”

RDS 106: “What name are you looking for?”

user 136: “Milestart”

RDS 106: “Do you care about section width?”

user 136: “I don't know”

RDS 106: “Do you care about section width?”

user 136: “I don't know”

RDS 106: “What else are you looking for?”

user 106: “Good traction”

RDS 106: “Do you care about tread pattern?

user 136: “Yes”

RDS 106: “What tread pattern are you looking for?”

user 136: “symmetrical”

. . . .”

It should be appreciated that in the above-disclosed example recommendation dialog the brand-related recommendation dialog queries have the highest priority, the highest-cost-or-price-related recommendation dialog queries have the second highest priority, and the rim-size-related recommendation dialog queries have the third highest priority, etc., which corresponds to the relative relevancies of “brand,” “highest_cost_or_price,” “rim_size,” etc. in the above-disclosed example semantic data model.

The RDS 106 also includes a dialog-session-management module (“DSMM”) 184.

The DSMM 184 is communicatively coupled to the NIM 142. The DSMM 184 is also communicatively coupled to the DTGM 166. The DSMM 184 is configured to manage or control a recommendation-dialog session in accordance with aspects of the present disclosure. More particularly, the DSMM 184 is configured to employ syntactic and semantic analysis and/or other natural language understanding (“NLU”) or natural language processing (“NLP”) techniques to determine intents and entities, optimal word sequences, phrase structure, and/or otherwise interpret recommendation dialog inputs received (through the one or more user devices 118, the network 112, and the NIM 142) from the user 136. Further, the DSMM 184 is also configured to use the intents and entities, optimal word sequences, phrase structure, and/or other interpretations of the recommendation dialog inputs to navigate the dialog trees (generated by the DTGM 166) to determine a set of one or more product or service recommendations. Further, the DSMM 184 is also configured to provide the corresponding recommendation-dialog queries and one or more product or service recommendations to the user 136 (through the NIM 142, the network 112, and the one or more user devices 118).

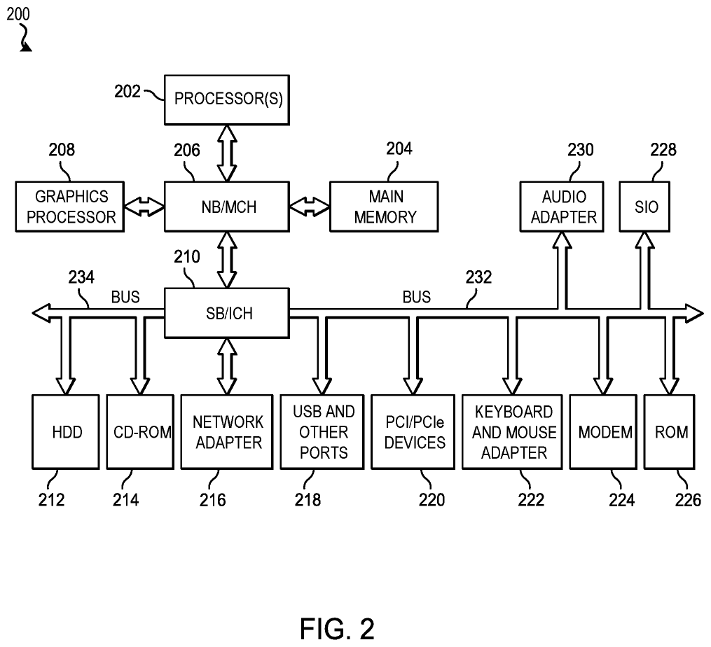

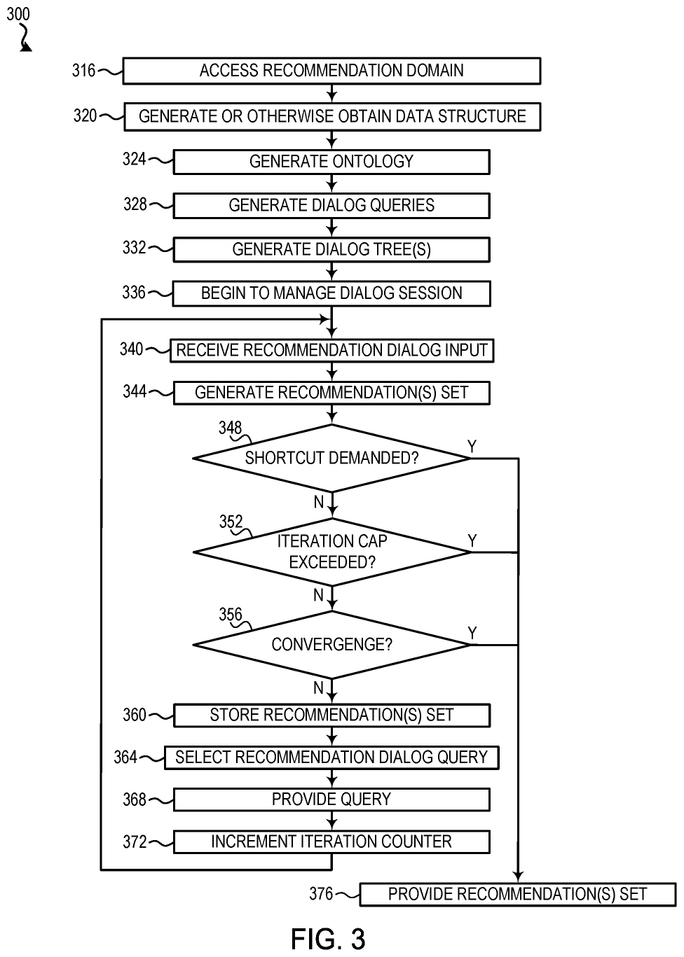

FIG. 2 is a block diagram illustrating a hardware architecture of a data processing system 200 in accordance with aspects of the present disclosure. The RDS 106 (see, e.g. FIG. 1) may be implemented using the data processing system 200. Additionally, the data processing system 200 may be configured to store and execute instructions for performing the method 300 (see, e.g. FIG. 3) as well as any other processes described herein. The data processing system 200 employs a hub architecture including north bridge and memory controller hub (“NB/MCH”) 206 and south bridge and input/output (“I/O”) controller hub (“SB/ICH”) 210. Processor(s) 202, main memory 204, and graphics processor 208 are connected to NB/MCH 206. Graphics processor 208 may be connected to NB/MCH 206 through an accelerated graphics port (“AGP”). A computer bus, such as bus 232 or bus 234, may be implemented using any type of communication fabric or architecture that provides for a transfer of data between different components or devices attached to the fabric or architecture.

Network adapter 216 connects to SB/ICH 210. Audio adapter 230, keyboard and mouse adapter 222, modem 224, read-only memory (“ROM”) 226, hard disk drive (“HDD”) 212, compact disk read-only memory (“CD-ROM”) drive 214, universal serial bus (“USB”) ports and other communication ports 218, and peripheral component interconnect/peripheral component interconnect express (“PCI/PCIe”) devices 220 connect to SB/ICH 210 through bus 232 and bus 234. PCI/PCIe devices may include, for example, Ethernet adapters, add-in cards, and personal computing (“PC”) cards for notebook computers. PCI uses a card bus controller, while PCIe does not. ROM 226 may comprise, for example, a flash basic input/output system (“BIOS”). Modem 224 or network adapter 216 may be used to transmit and receive data over a network.

HDD 212 and CD-ROM drive 214 connect to SB/ICH 210 through bus 234. HDD 212 and CD-ROM drive 214 may use, for example, an integrated drive electronics (“IDE”) or serial advanced technology attachment (“SATA”) interface. In some embodiments, the HDD 212 may be replaced by other forms of data storage devices including, but not limited to, solid-state drives (“SSDs”). A super I/O (“SIO”) device 228 may be connected to SB/ICH 210. SIO device 228 may comprise a chip on the motherboard that is configured to assist in performing less demanding controller functions for the SB/ICH 210 such as controlling a printer port, controlling a fan, and/or controlling the small light emitting diodes (“LEDS”) of the data processing system 200.

The data processing system 200 may include a single processor 202 or may include a plurality of processors 202. Additionally, processor(s) 202 may have multiple cores. In some embodiments, data processing system 200 may employ a large number of processors 202 that include hundreds or thousands of processor cores. In some embodiments, the processors 202 may be configured to perform a set of coordinated computations in parallel.

An operating system is executed on the data processing system 200 using the processor(s) 202. The operating system coordinates and provides control of various components within the data processing system 200. Various applications and services may run in conjunction with the operating system. Instructions for the operating system, applications, and other data are located on storage devices, such as one or more of the HDD 212, and may be loaded into main memory 204 for execution by processor(s) 202. In some embodiments, additional instructions or data may be stored on one or more external devices. The processes described herein for the illustrative embodiments may be performed by processor(s) 202 using computer usable program code, which may be located in a memory such as, for example, main memory 204, ROM 226, or in one or more peripheral devices.

FIG. 3 is a flowchart illustrating a computer-implemented recommendation-dialog method 300 in accordance with aspects of the present disclosure. The method 300 may be performed by the RDS 106 (see, e.g., FIG. 1), which may be implemented using the data processing system 200 (see, e.g., FIG. 2). Accordingly, the description of the method 300 is made with reference to components and operations of the RDS 106 and the data processing system 200. Nevertheless, it should be appreciated that the method 300 and/or any one or more of the particular steps of the method 300 may be performed by any other suitable device or system.

At step 316, the RDS 106 accesses (through the network 112) a recommendation domain from the knowledge-base modules 124. After step 316, operations of the RDS 106 go to step 320 (described further below).

At step 320, the DSM 148 generates or otherwise obtains a data structure suitable for generating an ontology. To generate the data structure, the DSM 148 uses a structure-mapping engine (“SME”) and/or any other suitable feature(s) to apply structure-mapping and/or other suitable techniques to generate the data structure based on source material from the recommendation domain. Alternatively, to otherwise obtaining the data structure, the DSM 148 receives (through the network 112 and the NIM 142) and adopts a predetermined or predefined data structure from the one or more user devices 118, the one or more knowledge-base modules 124, the one or more other network devices 130, and/or one or more suitable Internet resources. In either event, the DSM 148 also appends the data structure (as metadata) to the source material. After step 320, operations of the RDS 106 go to step 324 (described further below).

At step 324, the OGM 154 uses bag-of-words, predicate-argument-structure (“PAS”), and/or one or more other suitable types of semantic analyses to generate a semantic data model, knowledge graph, or other suitable ontology based on the data structure generated by the DSM 148 (described above) and suitable information from the recommendation domain. More particularly, the OGM 154 generates the ontology by reviewing and analyzing the recommendation domain for meanings, relationships, significances, and/or other ontological attributes or characteristics of terms or other information that comprise the data structure. After step 324, operations of the RDS 106 go to step 328 (described further below).

At step 328, the DQGM 160 uses one or more grammar and/or other natural language generation (“NLG”) techniques to generate one or more recommendation-dialog queries based on properties of the data structure. More particularly, the DQGM 160 generates Type 1, Type 2, and Type 3 recommendation-dialog queries by inserting properties of the data structure into respective recommendation-dialog-query templates related to the properties, and the DQGM 160 generates more open-ended Type 3 recommendation-dialog queries directed to soliciting a response that might help the RDS 106 choose an appropriate Type 1 recommendation-dialog query and/or an appropriate an appropriate Type 2 recommendation-dialog query. After step 328, operations of the RDS 106 go to step 332 (described further below).

At step 332, the DTGM 166 generates one or more dialog trees based on the ontology and the recommendation-dialog queries. More particularly, the DTGM 166 dynamically arranges the recommendation-dialog queries into the one or more dialog trees (in which Type 1 recommendation-dialog queries are prioritized over Type 2 recommendation-dialog queries and in which Type 3 recommendation-dialog queries are used as fallbacks for choosing appropriate Type 1 recommendation-dialog queries and/or appropriate Type 2 recommendation-dialog queries) according to the relative relevancies of the data structure properties of the recommendation-dialog queries, with the relative relevancies considered to be the total numbers of occurrences of each corresponding data structure property in the semantic data model. After step 332, operations of the RDS 106 go to step 336 (described further below).

At step 336, the DSMM 184 begins to manage a recommendation-dialog session. Here, the DSMM 184 may suitably initialize and/or reset some variables used in the following steps. For example, in some embodiments, the DSMM 184 may initialize or reset an “iteration counter” (described further below) to zero. After step 336, operations of the RDS 106 go to step 340 (described further below).

At step 340, the DSMM 184 receives (through the one or more user devices 118, the network 112, and the NIM 142) a recommendation dialog input from the user 136. After step 340, operations of the RDS 106 go to step 344 (described further below).

At step 344, the DSMM 184 employs syntactic and semantic analysis and/or other natural language understanding (“NLU”) or natural language processing (“NLP”) techniques to determine intents and entities, optimal word sequences, phrase structure, and/or otherwise interpret the recommendation dialog input. Further, the DSMM 184 uses the intents and entities, optimal word sequences, phrase structure, and/or other interpretations of the recommendation dialog inputs to navigate the dialog trees (generated by the DTGM 166) to determine a set of one or more product or service recommendations. After step 344, operations of the RDS 106 go to step 348 (described further below).

At step 348, the DSMM 184 determines whether the recommendation dialog input requests a “shortcut.” As used herein, shortcut means a user-initiated termination of a recommendation dialog session. For example, the user 136 may input something like “That's enough,” “Stop,” “Give me your best recommendation now,” etc. If the DSMM 184 determines that the recommendation dialog input requests a shortcut, then operations of the RDS 106 go to step 376 (described further below); otherwise, operations of the RDS 106 go to step 352 (described further below).

At step 352, the DSMM 184 determines whether an “iteration cap” has been exceeded. As used herein, iteration cap means a predetermined number of iterations through a recommendation dialog session. It should be appreciated that the iteration cap may, among other things, avoid the RDS 106 becoming trapped in an endless loop when a recommendation dialog session does not achieve “convergence” (described below). If the DSMM 184 determines that the iteration cap has been exceeded, then operations of the RDS 106 go to step 376 (described further below); otherwise, operations of the RDS 106 go to step 356 (described further below).

At step 356, the DSMM 184 determines whether the recommendation dialog session has achieved “convergence.” As used herein, convergence means a state when the ultimate product or service recommendation that is being formulated is no longer substantially affected by responses of the user 136 to the recommendation dialog queries. For example, a recommendation dialog session has achieved convergence when the DSMM 184 derives meaningful information from a recommendation dialog input, but the viable set of potential recommendations no longer changes. In some embodiments, determinations of convergence may be used in combination with entropy-based feature selection and/or other suitable techniques. If the DSMM 184 determines that the recommendation dialog session has achieved convergence, then operations of the RDS 106 go to step 376 (described further below); otherwise, operations of the RDS 106 go to step 360 (described further below).

At step 360, the DSMM 184 stores the set of one or more product or service recommendations in, for example, the main memory 204. After step 360, operations of the RDS 106 go to step 364 (described further below).

At step 364, the DSMM 184 selects a recommendation dialog query using the recommendation dialog input, the ontology, and the dialog tree. After step 364, operations of the RDS 106 go to step 368 (described further below).

At step 368, the DSMM 184 provides (through the NIM 142, the network 112, and the one or more user devices 118) the selected recommendation dialog query to the user 136. After step 368, operations of the RDS 106 go to step 372 (described further below).

At step 372, the DSMM 184 increments the “iteration counter.” As used herein, iteration counter means a variable that can be used to count a number of recommendation dialog input and recommendation dialog query pairings. For example, when a recommendation dialog session has only progressed through a first recommendation dialog input such as “I need a recommendation for tires” and a first recommendation dialog query such as “Do you care about brand?” the iteration counter may have a value of 1; whereas, when the recommendation dialog session has progressed through a second recommendation dialog input such as “Yes, I do care about brand” and a second recommendation dialog query such as “Do you care about highest cost or price?” then the iteration counter may have a value of 2; etc. After step 372, operations of the RDS 106 go to step 340 (described above).

At step 376, the DSMM 184 provides (through the NIM 142, the network 112, and the one or more user devices 118) the set of one or more product or service recommendations to the user 136.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In accordance with aspects of the present disclosure, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for engaging in a recommendation-dialog with a user, the method comprising:
accessing a recommendation domain;
using a structure-mapping technique to generate a data structure based on source material from the recommendation domain;
using semantic analyses to generate an ontology based on the data structure and the recommendation domain;
generating recommendation-dialog queries based on properties of the data structure;
generating a dialog tree based on the ontology and the recommendation-dialog queries;
receiving a recommendation dialog input;
navigating the dialog tree to determine a recommendation; and
providing the recommendation to the user.

2. The method of claim 1, wherein using semantic analyses to generate the ontology based on the data structure and the recommendation domain includes analyzing the recommendation domain for ontological attributes of terms that comprise the data structure.

3. The method of claim 2, wherein analyzing the recommendation domain for ontological attributes of terms that comprise the data structure includes using at least one technique selected from the group consisting of a bag-of-words technique and a predicate-argument-structure technique.

4. The method of claim 3, wherein generating the dialog tree based on the ontology and the recommendation-dialog queries includes arranging the recommendation-dialog queries according to relative relevancies of data structure properties of the recommendation-dialog queries.

5. The method of claim 4, wherein arranging the recommendation-dialog queries according to relative relevancies of data structure properties of the recommendation-dialog queries includes considering the relative relevancies of data structure properties of the recommendation-dialog queries to be total numbers of occurrences of each corresponding data structure property in a semantic data model.

6. The method of claim 5, wherein generating the recommendation-dialog queries based on properties of the data structure includes inserting properties of the data structure into recommendation-dialog-query templates.

7. The method of claim 6, wherein receiving the recommendation dialog input includes receiving an audible recommendation dialog input.

8. A system for engaging in a recommendation-dialog with a user, the system comprising:
a memory having instructions therein; and
at least one processor in communication with the memory, wherein the at least one processor is configured to execute the instructions to:
access a recommendation domain;
use a structure-mapping technique to generate a data structure based on source material from the recommendation domain;
use semantic analyses to generate an ontology based on the data structure and the recommendation domain;
generate recommendation-dialog queries based on properties of the data structure;
generate a dialog tree based on the ontology and the recommendation-dialog queries;
receive a recommendation dialog input;
navigate the dialog tree to determine a recommendation; and
provide the recommendation to the user.

9. The system of claim 8, wherein the at least one processor is configured to execute the instructions to analyze the recommendation domain for ontological attributes of terms that comprise the data structure.

10. The system of claim 9, wherein the at least one processor is configured to execute the instructions to use at least one technique selected from the group consisting of a bag-of-words technique and a predicate-argument-structure technique.

11. The system of claim 10, wherein the at least one processor is configured to execute the instructions to arrange the recommendation-dialog queries according to relative relevancies of data structure properties of the recommendation-dialog queries.

12. The system of claim 11, wherein the at least one processor is configured to execute the instructions to consider the relative relevancies of data structure properties of the recommendation-dialog queries to be total numbers of occurrences of each corresponding data structure property in a semantic data model.

13. The system of claim 12, wherein the at least one processor is configured to execute the instructions to insert properties of the data structure into recommendation-dialog-query templates.

14. The system of claim 13, wherein the at least one processor is configured to execute the instructions to receive an audible recommendation dialog input.

15. A computer program product, the computer program product comprising a computer readable storage medium having program instructions embodied therewith, the program instructions executable by at least one processor to cause the at least one processor to:
access a recommendation domain;
use a structure-mapping technique to generate a data structure based on source material from the recommendation domain;
use semantic analyses to generate an ontology based on the data structure and the recommendation domain;
generate recommendation-dialog queries based on properties of the data structure;
generate a dialog tree based on the ontology and the recommendation-dialog queries;
receive a recommendation dialog input;
navigate the dialog tree to determine a recommendation; and
provide the recommendation to the user.

16. The computer program product of claim 15, wherein the program instructions are executable by the at least one processor to cause the at least one processor to analyze the recommendation domain for ontological attributes of terms that comprise the data structure.

17. The computer program product of claim 16, wherein the program instructions are executable by the at least one processor to cause the at least one processor to use at least one technique selected from the group consisting of a bag-of-words technique and a predicate-argument-structure technique.

18. The computer program product of claim 17, wherein the program instructions are executable by the at least one processor to cause the at least one processor to arrange the recommendation-dialog queries according to relative relevancies of data structure properties of the recommendation-dialog queries.

19. The computer program product of claim 18, wherein the program instructions are executable by the at least one processor to cause the at least one processor to consider the relative relevancies of data structure properties of the recommendation-dialog queries to be total numbers of occurrences of each corresponding data structure property in a semantic data model.

20. The computer program product of claim 19, wherein the program instructions are executable by the at least one processor to cause the at least one processor to insert properties of the data structure into recommendation-dialog-query templates.
